(19) United States
(12) Patent Application Publication
(10) Pub. No.: US 2006/0118069 A1
(43) Pub. Date: Jun. 8, 2006

(54) Carburetor and intake air heating arrangements for V-twin engines

(76) Inventor: Dale D. Snyder, Neenah, WI (US)

Correspondence Address: BAKER & DANIELS LLP;111 E. WAYNE STREET, SUITE 800, FORT WAYNE, IN, 46802, US

(21) Appl. No.: 11/005,549

(22) Filed: Dec. 6, 2004

(51) Int. Cl. F02B 75/22; F02M 31/06

(52) U.S. Cl. 123/54.4; 123/543

(57) ABSTRACT

An apparatus and method for heating the intake air which is drawn into the carburetor of a V-twin engine, as well as an apparatus and method for heating the carburetor itself. The V-twin engine includes a crankcase and a pair of cylinders attached to the crankcase and defining a V-space therebetween, and one or more additional engine structures such as a shroud, fuel tank, and muffler, for example, cooperate with the cylinders to substantially enclose the V-space except for one or more air inlet gaps between the foregoing engine structures and the cylinders. During running of the engine, the V-space is heated by radiant heat from the muffler and the cylinders, and the carburetor, which is positioned within the V-space, is also heated to prevent “freeze-up” of the carburetor. Intake air is drawn through the air inlet gaps into the V-space, and is heated before entering the carburetor. In other embodiments, one or more exhaust outlets from the muffler and/or exhaust conduits of the engine exhaust system may be located in airflow communication with the V-space or the carburetor inlet to aid in heating the V-space and the intake air which is drawn into the carburetor, respectively.

### BACKGROUND OF THE INVENTION

1. Field of the Invention

This invention relates to small internal combustion engines of the type commonly used in lawn mowers, lawn and garden tractors, snow throwers, other working implements, or in sport vehicles. In particular, the present invention relates to heating the intake air and the carburetors of such engines.

2. Description of the Related Art

Small internal combustion engines typically include a carburetor which mixes ambient atmospheric air with liquid fuel to provide an air/fuel mixture for combustion within the engine. Usually, the intake air is drawn from the atmosphere through an air filter to remove dirt and other debris from the intake air before the intake air enters the carburetor. A potential problem in such arrangements is that when the engine is used in a cold environment, such as with a snow thrower, the intake air is often cold and moist, and may include snow. The moisture in the cold intake air may freeze and accumulate within the carburetor, causing the carburetor to “freeze up” and inhibit good engine performance.

It is known to provide small single cylinder engines with duct arrangements which are disposed near the engine muffler. In operation, the duct is heated by radiant heat from the muffler during running of the engine. Air is drawn through the duct by the carburetor, and the air is heated before it enters the carburetor. However, such ducts are typically formed from two or more separate components which fit together and cooperate to define the duct, and therefore, multiple parts are required.

A further problem in many small engines is that the carburetor itself is often positioned in a manner in which it is exposed to the cold environment, potentially leading to carburetor “freeze up”. For example, the carburetor may be positioned on one side of the engine in such a manner that at least a portion of the body of the carburetor is disposed externally of the engine enclosure structure and is exposed to the environment.

What is needed is an intake air and/or carburetor heating arrangement for small internal combustion engines which is an improvement over the foregoing.

Also, intake air and/or carburetor heating arrangements which are adapted for use with V-twin engines are not known, thus, a further need is for an intake air and/or carburetor heating arrangement for a V-twin engine.

### SUMMARY OF THE INVENTION

The present invention provides an apparatus and method for heating the intake air which is drawn into the carburetor of a V-twin engine, as well as an apparatus and method for heating the carburetor itself. The V-twin engine includes a crankcase and a pair of cylinders attached to the crankcase and defining a V-space therebetween, and one or more additional engine structures such as a shroud, fuel tank, and muffler, for example, cooperate with the cylinders to substantially enclose the V-space except for one or more air inlet gaps between the foregoing engine structures and the cylinders. During running of the engine, the V-space is heated by radiant heat from the muffler and the cylinders, and the carburetor, which is positioned within the V-space, is also heated to prevent “freeze-up” of the carburetor. Intake air is drawn through the air inlet gaps into the V-space, and is heated before entering the carburetor. In other embodiments, one or more exhaust outlets from the muffler and/or exhaust conduits of the engine exhaust system may be located in airflow communication with the V-space or the carburetor inlet to aid in heating the V-space and the intake air which is drawn into the carburetor, respectively.

In one embodiment, the engine includes a pair of cylinders extending from the crankcase and defining opposite sides of a V-space in which the carburetor is positioned. A front side of the V-space is enclosed by a shroud which includes an air cleaner cavity in airflow communication with both the V-space and with the inlet of the carburetor. The rear side of the V-space is substantially enclosed by a muffler, and the top side of the V-space is substantially enclosed by a fuel tank. During running of the engine, radiant heat from the engine cylinders and the muffler heats the V-space, the carburetor, and the intake air which is drawn into the carburetor through the V-space to prevent “freeze-up” of the carburetor. Optionally, the muffler may include one or more outlet holes therein such that a portion of the exhaust gases from the engine are discharged into the V-space to aid in heating the V-space.

In another embodiment, the engine includes a pair of cylinders extending from the crankcase to define a V-space therebetween, and the carburetor is positioned within the V-space. The front side of the V-space is enclosed by a shroud which includes an air cleaner cavity in airflow communication with both the V-space and with the carburetor inlet. The exhaust system of the engine includes a pair of mufflers, one attached to the outside of each cylinder, and an exhaust conduit connected to the mufflers includes a portion disposed within the air cleaner cavity. The exhaust conduit portion within the air cleaner cavity includes one or more outlet openings through which a small portion of the exhaust gases of the engine are discharged into the air cleaner cavity for heating the intake air which is drawn into the carburetor inlet.

In one form thereof, the present invention provides an internal combustion engine, including a crankcase; a pair of cylinders extending from the crankcase and disposed at an angle with respect to one another to define a V-space therebetween; one or more additional engine structures attached to at least one of the crankcase and the cylinders and cooperating with the cylinders to substantially enclose the V-space, the additional engine structures including a muffler; and a carburetor positioned within the V-space, whereby during operation of the engine, heat from the cylinders and the muffler radiates into the V-space and the carburetor is heated thereby.

In another form thereof, the present invention provides an internal combustion engine, including a crankcase; a pair of cylinders extending from the crankcase and disposed at an angle with respect to one another to define a V-space therebetween; one or more additional engine structures attached to at least one of the crankcase and the cylinders and cooperating with the cylinders to substantially enclose the V-space apart from at least one air inlet; and a carburetor positioned within the V-space, whereby during operation of the engine, air is drawn into the V-space through the air inlet and is heated within the V-space by radiant heat from the cylinders prior to being drawn into the carburetor.

In a further form thereof, the present invention provides an internal combustion engine, including a crankcase; at least one cylinders extending from the crankcase: a carburetor including an inlet; and an exhaust conduit having a portion thereof disposed proximate the carburetor inlet, the exhaust conduit portion including at least one outlet therein, whereby exhaust gases from the exhaust conduit portion are discharged through the at least one outlet proximate the carburetor inlet, and air which is drawn into the carburetor inlet is heated thereby.

### BRIEF DESCRIPTION OF THE DRAWINGS

The above-mentioned and other features and advantages of this invention, and the manner of attaining them, will become more apparent and the invention itself will be better understood by reference to the following description of embodiments of the invention taken in conjunction with the accompanying drawings, wherein:

FIG. 1 is a front perspective view of a V-twin engine including a carburetor and intake air heating arrangement in accordance with the present invention, showing the air cleaner cavity of the engine shroud, and an air cleaner element and cover exploded therefrom;

FIG. 2 is a rear perspective view of the engine of FIG. 1, showing the V-space defined between the engine cylinders, which is substantially enclosed by the engine shroud, the fuel tank (shown exploded away from the engine), and the muffler (shown in dashed lines);

FIG. 3 is a top view of the engine of FIGS. 1 and 2, with the fuel tank represented in dashed lines, further showing the intake air flow into the engine;

FIG. 4 is a top view of the engine of FIG. 1 including an intake air and carburetor heating arrangement according to another embodiment, and further showing the intake air flow into the engine.

Corresponding reference characters indicate corresponding parts throughout the several views. The exemplifications set out herein illustrate preferred embodiments of the invention, and such exemplifications are not to be construed as limiting the scope of the invention any manner.

### DETAILED DESCRIPTION

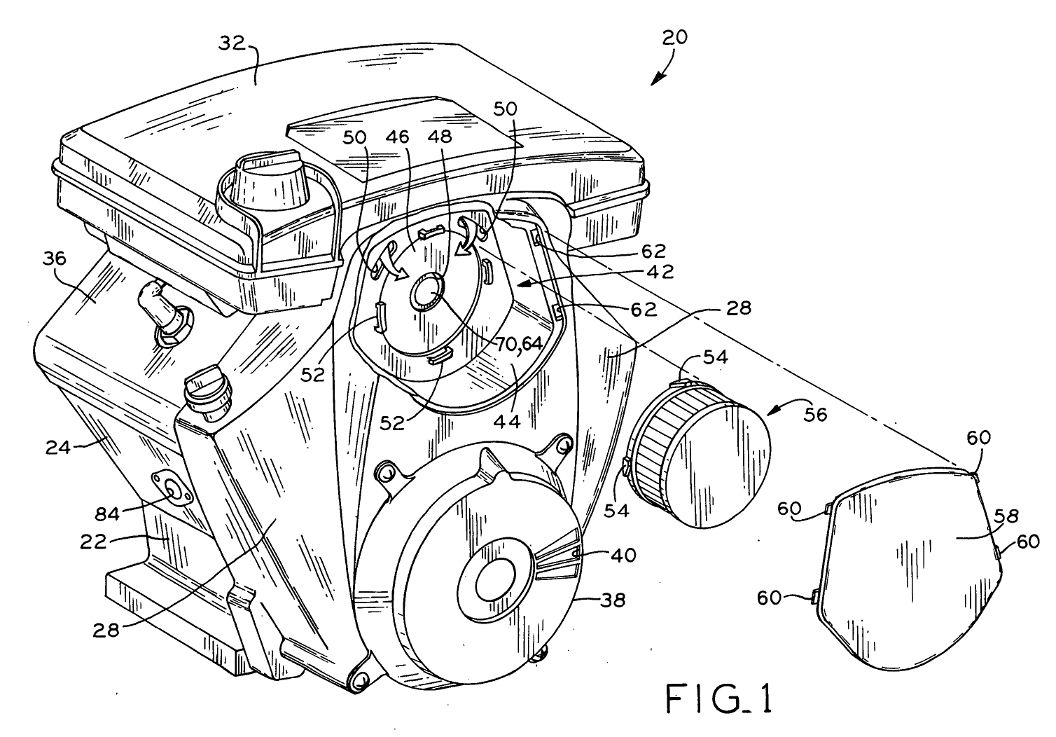

Referring to FIGS. 1-3, a small internal combustion engine 20 is shown as a horizontal crankshaft V-twin engine, such as that described in detail in U.S. patent application Ser. No. 10/409,262, entitled INTERNAL COMBUSTION ENGINE, filed on Apr. 8, 2003 (Attorney Docket Ref.: TEL0633-02), assigned to the assignee of the present invention, the disclosure of which is expressly incorporated herein by reference. Although engine 20 is shown as a horizontal crankshaft V-twin engine, the present invention may also be embodied within vertical crankshaft V-twin engines.

Engine 20 generally includes crankcase 22 having a pair of engine cylinders 24 mounted to crankcase 22 in the manner described in the above-incorporated U.S. patent application Ser. No. 10/409,262. Cylinders 24 extend generally upwardly from crankcase 22, and are disposed at an angle of approximately 90° with respect to one another, although the angular spacing between cylinders 24 may vary. Cylinders 24 define a V-space 26 or volume therebetween, with V-space 26 including a pair of opposing lateral sides, a front side, a rear side, and a top side. The inner, mutually facing walls of cylinders 24 define the lateral sides of V-space 26. The front side of V-space is enclosed by shroud 28, the rear side of V-space is substantially enclosed by muffler 30, and the top side of V-space is substantially enclosed by fuel tank 32. In this manner, V-space 26 is a volume which is substantially enclosed by the foregoing engine components, except for a plurality of air inlet gaps which are defined by the small clearance spaces between the foregoing engine components.

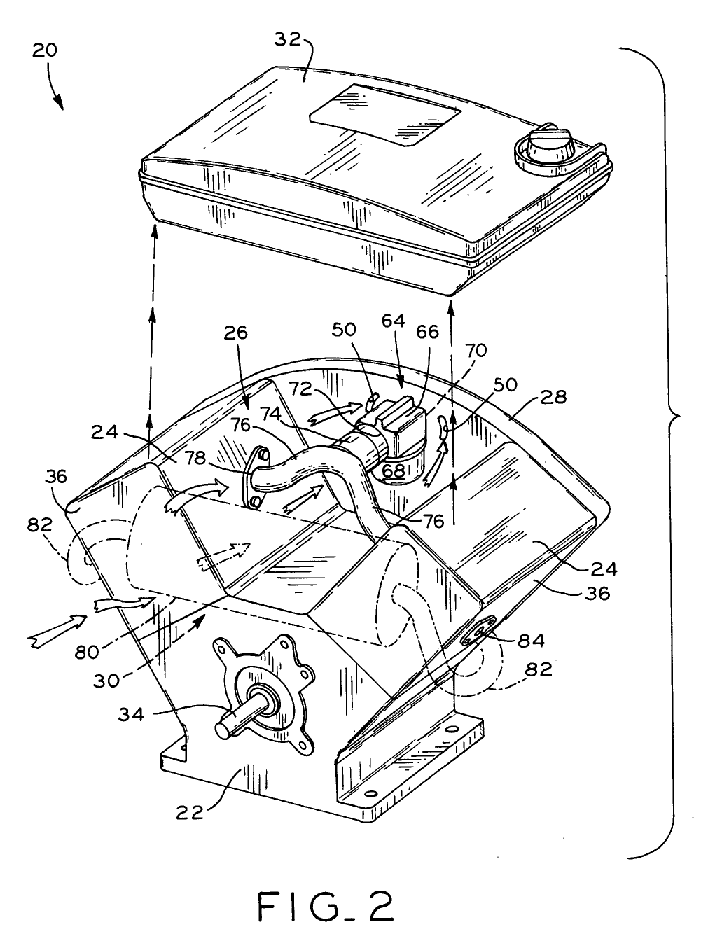

A horizontally disposed crankshaft 34 (FIG. 2) is rotatably carried within crankcase 22, and is coupled to a pair of conventional piston/connecting rod assemblies (not shown), one corresponding to each engine cylinder.

Engine cover or shroud 28 is connected to crankcase 22, and covers at least a portion of each of crankcase 22 and cylinders 24. Shroud 28 may be formed of metal, or from an injection-molded or vacuum-formed plastic material, for example. Cylinder wraps 36, typically made of a relatively thin sheet metal, are also connected to crankcase 22 and/or cylinders 24, and closely surround cylinders 24 for directing cooling air around cylinders 24 in the manner described below.

Air inlet screen 38 is mounted to shroud 28, and covers an opening in shroud 28 through which cooling air is drawn by rotation of the engine flywheel (not shown), which is attached to a front end of crankshaft 34 which extends externally of crankcase 22. Specifically, rotation of the flywheel draws cooling air through louvers 40 in screen 38 (only a few of which are shown in FIG. 1) and into an area defined between crankcase 22 and shroud 28. Thereafter, the cooling air flows between the outer walls of cylinders 24 and cylinder wraps 36 to cool cylinders 24. Additional details regarding engine 20, and in particular, the control system of engine 20, are discussed in detail in U.S. patent application Ser. No. 10/409,202, entitled ENGINE CONTROL SYSTEM, filed on Apr. 8, 2003 (Attorney Docket Ref.: TEL0683), assigned to the assignee of the present invention, the disclosure of which is expressly incorporated herein by reference.

In FIG. 1, shroud 28 includes an air cleaner cavity 42 defined therein, including side wall 44 and rear wall 46 which includes a central opening 48 and a plurality of air inlet slots 50. Air cleaner cavity 42 additionally includes a plurality of mounts 52 in rear wall 46 to which tabs 54 of air cleaner element 56 or filter are fitted to secure air cleaner element 56 within air cleaner cavity 42. Cover 58 includes a plurality of tabs 60 which are snap-fitted into apertures 62 provided around the outer periphery of air cleaner cavity 42 to secure cover 58 to shroud 28 to enclose air cleaner cavity 42. Further details regarding air cleaner cavity 42, air cleaner element 56, and cover 58 are disclosed in U.S. patent application Ser. No. 10/408,882, entitled AIR CLEANER ASSEMBLY FOR INTERNAL COMBUSTION ENGINES, filed on Apr. 8, 2003 (Attorney Docket Ref.: TEL0681), assigned to the assignee of the present invention, the disclosure of which is expressly incorporated herein by reference.

Fuel tank 32 is attached to the upper portion of cylinders 24 by suitable brackets (not shown) or other fastening structure, and contains a quantity of liquid fuel which is conveyed to the fuel bowl of carburetor 64 through suitable conduits (not shown) by a gravity feed or by a fuel pump, for example.

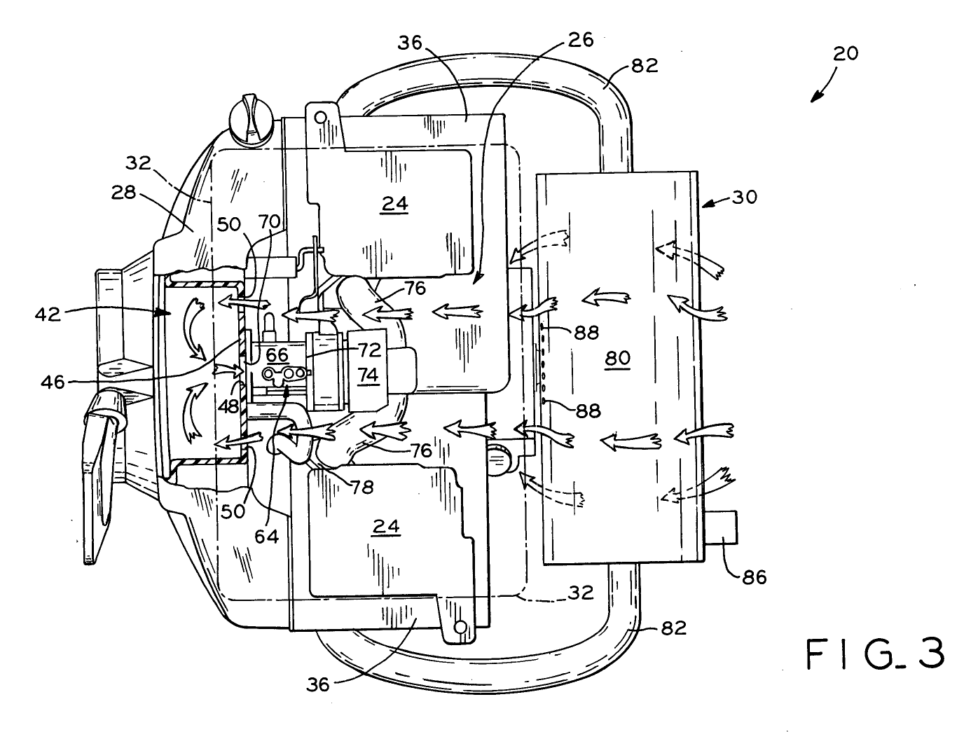

Referring to FIGS. 2 and 3, carburetor 64 is positioned within V-space 26, and generally includes carburetor body 66 and fuel bowl 68. A carburetor throat passage (not shown) extends through carburetor body 66 between inlet 70 and outlet 72 of carburetor 64. Inlet 70 of carburetor 64 is connected to rear wall 46 of air cleaner cavity 42 of shroud 28, such that inlet 70 of carburetor 64 is disposed adjacent to, and in airflow communication with, air cleaner cavity 42 via central opening 48 in rear wall 46 of air cleaner cavity 42. The outlet 72 of carburetor 64 is connected to intake manifold 74, which includes a pair of intake pipes 76 attached to intake ports 78 on the inner sides of cylinders 24. In operation, intake air drawn through carburetor 64 is mixed with fuel from fuel tank 32 in the venturi region of the carburetor 64 throat passage to form an air/fuel mixture which is drawn into cylinders 24 via intake manifold 74 and intake pipes 76 for combustion within cylinders 24 of engine 20. Carburetor 64 additionally includes a choke valve and throttle valve (not shown) therein, as is conventional.

Referring to FIGS. 2 and 3, muffler 30 is attached to engine 20 via suitable brackets or by other fasteners, for example, and includes muffler body 80 disposed proximate the rear side of V-space 26 such that muffler body 80 substantially encloses the rear side of V-space 26. A pair of exhaust conduits 82 extend between and connect exhaust ports 84 on the outer sides of cylinders 24 to muffler body 80. As shown in FIG. 3, muffler body 80 includes a main outlet pipe 86 extending rearwardly therefrom, through which the majority of the exhaust gases from engine 20 are discharged. Optionally, muffler 30 may additionally include one or more other outlets therein, shown in FIG. 3 in the form of a plurality of holes 88 in muffler body 80 which are aligned with the rear side of V-space 26. In operation, a small portion of the exhaust gases from engine 20 are discharged from muffler body 80 through holes 88 and into V-space 26, as described below.

Operation of the carburetor and intake air preheating arrangement of engine 20 according to the first embodiment of the present invention, shown in FIGS. 1-3, will now be described. During running of engine 20, radiant heat from cylinders 24 and from muffler 30 heats V-space 26 by virtue of V-space being substantially enclosed by cylinders 24, shroud 28, muffler 30, and fuel tank 32, wherein the heat from cylinders 24 and muffler 30 tends to be trapped with, or collect or accumulate within V-space 26. In this manner, V-space 26 is heated during the running of engine 20, and in turn, carburetor 64 is also heated to thereby prevent “freeze-up” of carburetor 64 when engine 20 is used in a cold environment, such as on a snow-thrower, for example.

As represented by the arrows in FIGS. 1-3, intake air for engine 20 is drawn into V-space 26 through one or more of the air inlet gaps between muffler 30 and cylinders 24, between muffler 30 and crankcase 22, and between muffler 30 and fuel tank 32, for example, and passes into V-space 26. The intake air passes closely around muffler 30 into V-space 26, and is heated by radiant heat from muffler 30. The intake air is further heated within V-space 26 as the air passes through V-space 26 by the heat which collects within V-space from cylinders 24 and muffler 30, as described above.

Further, a small portion of the hot exhaust gases from engine 20 may be discharged through holes 88 in muffler body 80 into V-space 26, which further heats the interior of V-space 26 and the intake air which passes through V-space 26. Because the volume of hot exhaust gases which are discharged into V-space 26 through holes 88 in muffler body 80 is relatively small in comparison to the much larger volume of hot exhaust gases which are discharged into the atmosphere through main outlet pipe 84 of muffler body 80, the exhaust gases which are discharged into V-space 26 do not adversely effect the performance of engine 20.

After passing through V-space 26, the intake air passes through air intake slots 50 in rear wall 46 of air cleaner cavity 42 and into air cleaner cavity 42, as illustrated by the arrows in FIGS. 1-3. In air cleaner cavity 42, the heated intake air passes through air cleaner element 56 to remove dirt, dust, and other debris from the intake air. Thereafter, the heated intake air passes through central opening 48 in rear wall 46 of air cleaner cavity 42 and into inlet 70 of carburetor 64 for mixing with fuel from fuel tank 32 to form an air/fuel combustion mixture for combustion within engine 20. Advantageously, in the foregoing manner, the intake air of engine 20 is heated by passing around muffler 30 and through V-space 26 before same enters air cleaner cavity 42 and carburetor 64, such that snow or other moisture is removed from the intake air before same passes through air cleaner element 56 and into carburetor 64, thereby preventing “freeze up” of the foregoing components.

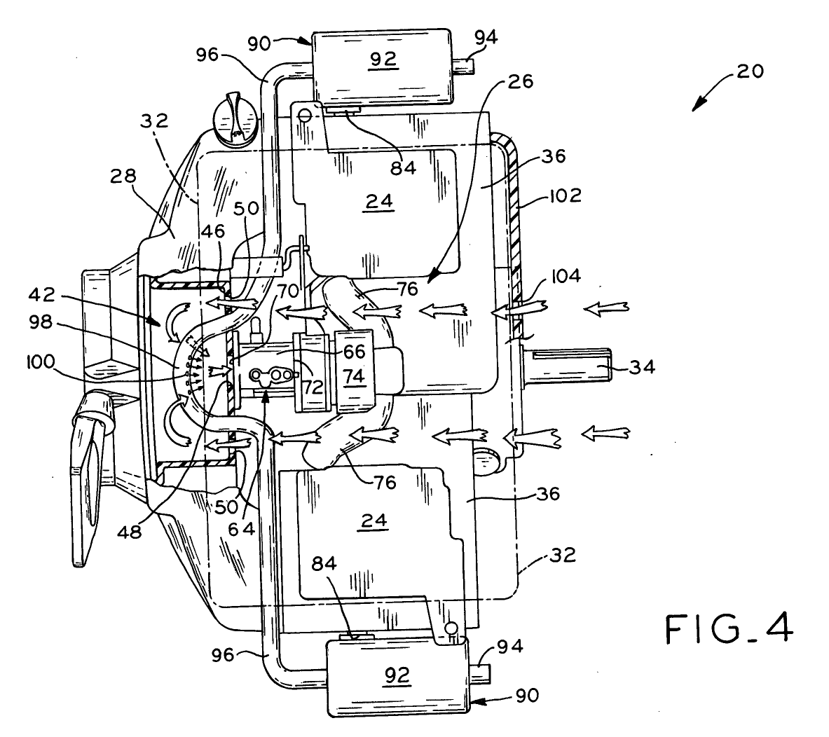

A carburetor and intake air preheating arrangement for engine 20 according to a second embodiment will now be described with reference to FIG. 4. Except as described below, the structure of engine 20 is identical to that described in the first embodiment of FIGS. 1-3, and the same reference numerals have been used in FIG. 4 to designate identical or substantially identical structures of engine 20 between the first embodiment of FIGS. 1-3 and the second embodiment of FIG. 4.

Engine 20 includes a pair of mufflers 90 respectively attached to exhaust ports 84 of cylinders 24, with mufflers 90 disposed on the outer sides of cylinders 24 externally of V-space 26. Further details regarding the construction and operation of mufflers 90 and the manner in which same are attached to engine 20 are disclosed in U.S. patent application Ser. No. 10/778,826, entitled “EXHAUST SYSTEM FOR V-TWIN ENGINES”, filed on Feb. 16, 2004 (Attorney Docket Ref.: TEL0692-01), assigned to the assignee of the present invention, the disclosure of which is expressly incorporated herein by reference.

Mufflers 90 each include a muffler body 92 having a main exhaust outlet pipe 94 through which the majority of the exhaust gases from engine 20 are discharged. An exhaust conduit 96 is connected to each of the muffler bodies 92 at opposite ends thereof, and includes a curved or bent portion 98 disposed within air cleaner cavity 42 of shroud 28. Exhaust conduit portion 98 includes one or more outlets, shown in FIG. 4 in the form of a plurality of holes 100, through which a relatively small portion of the exhaust gases of engine 20 are discharged into air cleaner cavity 42 proximate central opening 48 in rear wall 46 of air cleaner cavity 42 and carburetor inlet 70. In this embodiment, air cleaner cavity 42 may lack air cleaner element 56 to allow for the positioning of portion 98 of exhaust conduit 96 therein. Alternatively, the shape of air cleaner element 56 may be modified such that air cleaner element 56 may be positioned within air cleaner cavity 42 adjacent portion 98 of exhaust conduit 96.

In operation, radiant heat from cylinders 24 during running of engine 20 heats V-space 26 and carburetor 64 in the same manner described above with respect to the embodiment of FIGS. 1-3. A portion of this heat may escape through the rear side of V-space 26 or alternatively, engine 20 may include a wall 102 or other structure mounted to crankcase 22 or cylinders 24 for substantially enclosing the rear side of V-space 26 as desired, with such wall 102 optionally including one or more air inlet openings 104 therein. Only a portion of wall 102 is shown in FIG. 4 for clarity.

Intake air flows through V-space 26 as illustrated by the arrows in FIG. 4, and is heated by radiant heat from the cylinders 24. After the intake air passes through air intake slots 50 in rear wall 46 of air cleaner cavity 42, the intake air mixes with the exhaust gases which are discharged through holes 100 in exhaust conduit portion 98 to further heat the intake air in air cleaner cavity 42 before the intake air is drawn into inlet 70 of carburetor 64. Because the amount of hot exhaust gases which are discharged into air cleaner cavity 42 through holes 100 in exhaust conduit portion 98 is relatively small in comparison to the larger amount of hot exhaust gases which are discharged into the atmosphere through the main outlet pipes 94 of mufflers 90, the exhaust gases which are discharged into air cleaner cavity 42 do not adversely effect the performance of engine 20.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An internal combustion engine, comprising:
a crankcase;
a pair of cylinders extending from said crankcase and disposed at an angle with respect to one another to define a V-space therebetween;
one or more additional engine structures attached to at least one of said crankcase and said cylinders and cooperating with said cylinders to substantially enclose said V-space, said additional engine structures including a muffler; and
a carburetor positioned within said V-space, whereby during operation of said engine, heat from said cylinders and said muffler radiates into said V-space and said carburetor is heated thereby.

2. The engine of claim 1, wherein said V-space includes a pair of opposing sides respectively defined by said cylinders, and further includes a front side, a rear side, and a top side.

3. The engine of claim 2, wherein said muffler at least partially encloses said rear side of said V-space.

4. The engine of claim 3, wherein said muffler includes at least one outlet in airflow communication with said V-space, whereby exhaust gases from said muffler are discharged through said at least one outlet into said V-space.

5. The engine of claim 2, wherein said additional engine structures include at least one of:
a shroud, said shroud enclosing one of said front and top sides of said V-space; and
a fuel tank, said fuel tank enclosing the other of said front and top sides of said V-space.

6. The engine of claim 1, further comprising a cover cooperating with said shroud to define an air cleaner cavity therebetween, said air cleaner cavity in airflow communication with said V-space and with said carburetor and including an air cleaner element therein.

7. The engine of claim 6, further comprising an exhaust conduit having a portion thereof disposed within said air cleaner cavity, said exhaust conduit portion including at least one outlet therein, whereby exhaust gases from said exhaust conduit portion are discharged through said at least one outlet into said air cleaner cavity.

8. An internal combustion engine, comprising:
a crankcase;
a pair of cylinders extending from said crankcase and disposed at an angle with respect to one another to define a V-space therebetween;
one or more additional engine structures attached to at least one of said crankcase and said cylinders and cooperating with said cylinders to substantially enclose said V-space apart from at least one air inlet; and
a carburetor positioned within said V-space, whereby during operation of said engine, air is drawn into said V-space through said air inlet and is heated within said V-space by radiant heat from said cylinders prior to being drawn into said carburetor.

9. The engine of claim 8, wherein said V-space includes a pair of opposing sides respectively defined by said cylinders, and further includes a front side, a rear side, and a top side.

10. The engine of claim 9, wherein said additional engine structures include at least one of:
a shroud, said shroud enclosing one of said front and top sides of said V-space;
a fuel tank, said fuel tank enclosing the other of said front and top sides of said V-space; and
a muffler, said muffler enclosing said rear side of said V-space.

11. The engine of claim 9, further comprising a muffler at least partially enclosing said rear side of said V-space.

12. The engine of claim 11, wherein said muffler includes at least one outlet in airflow communication with said V-space, whereby exhaust gases from said muffler are discharged through said at least one outlet into said V-space.

13. The engine of claim 8, further comprising a cover cooperating with said shroud to define an air cleaner cavity therebetween, said air cleaner cavity in airflow communication with said V-space and with said carburetor and including an air cleaner element therein.

14. The engine of claim 13, further comprising an exhaust conduit having a portion thereof disposed within said air cleaner cavity, said exhaust conduit portion including at least one outlet therein, whereby exhaust gases from said exhaust conduit portion are discharged through said at least one outlet into said air cleaner cavity.

15. An internal combustion engine, comprising:
a crankcase;
at least one cylinder extending from said crankcase:
a carburetor including an inlet; and
an exhaust conduit having a portion thereof disposed proximate said carburetor inlet, said exhaust conduit portion including at least one outlet therein, whereby exhaust gases from said exhaust conduit portion are discharged through said at least one outlet proximate said carburetor inlet, and air which is drawn into said carburetor inlet is heated thereby.

16. The engine of claim 15, wherein said engine includes a pair of cylinders extending from said crankcase and disposed at an angle with respect to one another to define a V-space therebetween, said carburetor positioned within said V-space.

17. The engine of claim 15, further comprising an air cleaner cavity in airflow communication with said carburetor inlet, said exhaust conduit portion disposed within said air cleaner cavity.

18. The engine of claim 17, wherein said engine further includes a shroud and a cover cooperating with one another to define said air cleaner cavity, said air cleaner cavity attached to said carburetor inlet.

19. The engine of claim 15, wherein said outlet comprises a plurality of holes in said exhaust conduit portion.
